(19) United States
(12) Patent Application Publication
(10) Pub. No.: US 2007/0283394 A1
(43) Pub. Date: Dec. 6, 2007

(54) Point of sale video server and method of using same

(75) Inventor: Robert Allan Unger, El Cajon, CA (US)

Correspondence Address: RADER FISHMAN & GRAUER PLLC, LION BUILDING, 1233 20TH STREET N.W., SUITE 501, WASHINGTON, DC, 20036, US

(73) Assignee: Sony Electronics Inc. and Sony Corporation

(21) Appl. No.: 11/523,647

(22) Filed: Sep. 20, 2006

Related U.S. Application Data
(60) Provisional application No. 60/810,143, filed on Jun. 2, 2006.

(51) Int. Cl. G06F 13/00; H04N 5/445; G06F 3/00

(52) U.S. Cl. 725/60; 725/61; 725/37

(57) ABSTRACT

A server stores video streams and is connected to thin clients through a network connection. Each thin client includes an addressable input to receive the video streams from the server, a decoder to properly decode the stream, and an output to deliver content to a connected video display product in the desired format. The video server also stores configuration settings, including the information that allows the plurality of thin clients to be addressed, as well as information about the connected television, such as make and brand, as well as specification information. User interfaces allow input of this information and controlling client display (e.g., selecting content). The user interface for controlling client display is preferably accessible through a telephone connection.

### CROSS REFERENCE TO RELATED APPLICATIONS

This application claims the benefit under 35 U.S.C. §119 of provisional application Ser. No. 60/810,143, filed on Jun. 2, 2006 and entitled “Point of Sale Video Server and Method of Using Same,” the entire contents of which are hereby incorporated by reference.

### BACKGROUND OF THE INVENTION

1. Field of the Invention

This invention relates to providing content to video display products, more particularly to providing content to video display products in a retail point-of-sale environment, and still more particularly to providing video content streams to thin clients respectively connected to video display products and accommodating selection of particular content from the provided video content streams by addressing and configuring the thin clients.

2. Description of the Related Art

Point of sale promotional methods are well known for use in a retail environment, each tailored to the location, product, consumer, and the like. A significant amount of money is generated from the sales of electronic equipment, especially television sets, at a retail outlet. At such outlets, a potential customer faces an overwhelming number of choices with differentiations that are not always readily apparent.

It is a general difficulty in such environments, with a minimum amount of sales assistance, to display content that the customer wants to see on the video display products (e.g., television sets) that the customer wants to compare. This is especially true where technological advances produce significant variations in the capabilities of the television sets, and the sophistication of the consumers requires ever-increasing information about those capabilities. Often, customers want to review the type of content that they anticipate enjoying. For example, some customers may want to see an example of a particular sporting event on various sets for a side-by-side comparison, while others might be more interested in movies or other forms of content.

The task is made even more difficult because of the various formats in which content may be presented, the various devices that may be used to deliver signals related to the content to televisions, the various connectors and interfaces required by such devices (as well as the televisions).

Additionally, televisions may have different capabilities, including but not limited to digital and high definition (HD) television, as well as underlying display technology such as plasma technology, liquid crystal display (LCD), projection variances, and diverse broadcast streams from commercial television networks, cable systems, or other sources.

Moreover, side-by-side comparison selling is popular, but the variation in technology makes it difficult for retail sales assistants to maintain a level of technological sophistication sufficient to induce a consumer to make a purchase, and to make a purchase of a particularly-favored or profitable television set. Thus, it would be desirable in a point of purchase display system and method of providing comprehensive content for displaying side-by-side comparisons of various television sets. The comprehensive content may include formats, such as 720p, 1080i, and 1080p; content motion from slow to fast; color space and contrast; up-conversion for non-native formats; and adequate technological comparisons such as might exist among plasma, LCD, DLP, and SXRD systems, for example.

Sourcing and delivering content to products that a customer wants to review is also problematic. Currently, showrooms for television sets use DVD players, cable feeds, satellite dishes, and similar sources for video to display on the televisions offered for sale. This approach may inappropriately connect content in a format that is not appropriate or at least not optimal for a given product. Thus, consumers are sometimes under-informed in their purchasing decisions.

What is needed is a system and corresponding method accommodating the comparison of video display products in a point of sale retail environment that facilities easy selection of desired content, and provides the selected content to respective products being compared in an appropriate format.

### SUMMARY OF THE INVENTION

The present invention facilitates the presentation of content on video display products (e.g., televisions) in a point-of-sale retail environment.

A server stores video streams and is connected to thin clients through a network connection. Each thin client includes an addressable input to receive the video streams from the server, a decoder to properly decode and/or encode the stream, and an output to deliver content to a connected television in the desired format.

The video server also stores configuration settings, including the information that allows the plurality of thin clients to be addressed, as well as information about the connected television, such as make, brand, and specification information (e.g., diagonal size, etc.).

A user interface allows input of this information, as well as commands selecting content, to the video server. The user interface is preferably accessible through a telephone connection.

The thin clients may also include a wireless output interface for a delivery of commands to connected television. This is helpful for controlling the television during installation or restoring configurations to default settings, or for providing a variety of control commands to the television.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating a point of sale video server system for facilitating the presentation of video display products in a point-of-sale retail environment in accordance with the present invention.

FIG. 2 is a block diagram illustrating a video server from a point of sale video server system in accordance with the present invention.

FIG. 3 is a block diagram illustrating a thin client from a point of sale video server system in accordance with the present invention.

FIGS. 4A-B are display diagrams illustrating examples of a user interface for providing instructions to the video server to deliver specific content to thin clients in accordance with the present invention.

FIG. 5 is a display diagram illustrating an example of a user interface for accommodating the management of content on the video server in accordance with the present invention.

FIG. 6 is a block diagram illustrating an alternative example of a remote control in accordance with the present invention.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

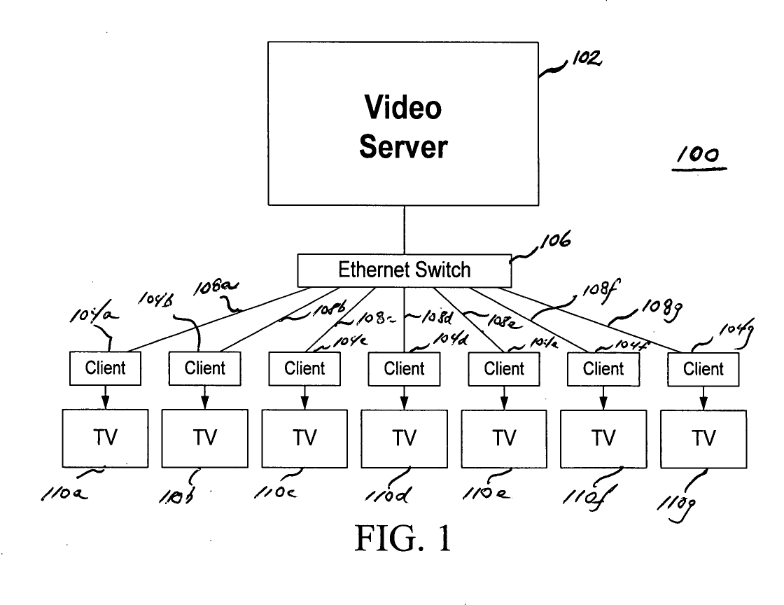

FIG. 1 is a block diagram illustrating a point of sale video server (POSVS) system 100 for facilitating the presentation of video display products in a point-of-sale retail environment in accordance with the present invention. The POSVS system 100 includes a video server 102 that is connected to thin clients 104a-g through a network switch 106 and corresponding network connections 108a-g. Each thin client 104a-g is configured to interface with a video display product such as a television set, illustrated as TVs 110a-g.

The video server 102 is preferably a computer having conventional hardware and related software for carrying out the functionality described herein. The video server 102 houses and broadcasts the content through a network connection to the thin clients 104a-g. The network connection, illustrated to include a network switch 106 and corresponding network connections 108a-g, is preferably conventional equipment such as an Ethernet switch and Ethernet cables. This configuration allows each thin client 104a-g to be connected to the video server 102 using the same type of cable, which avoids confusing arrays of connections. It also accommodates broadcast of video streams (e.g., MPEG) and corresponding addressing of thin clients to decode and deliver selected content as will be described.

Each thin client 104a-g is configured to receive video streams broadcast by the video server 102, to decode content and to provide the decoded content to the video display product to which it is connected. The thin clients 104a-g are also preferably configured to be addressable so that the video server 102 can deliver instructions that indicate which content in the broadcast streams should be selected, decoded and transmitted to the relevant video display product. This allows the video server 102 to receive instructions (e.g., from a user in the point-of-sale environment) and then cause them to be carried out by appropriately addressing and instructing the relevant thin client 104a-g. The thin clients 104a-g also include the ability to overlay local graphics on top of the distributed content. These overlays permit unique signage on each television screen.

The video server 102 is configured to store information that allows the plurality of thin clients 104a-g to be respectively addressed, to receive instructions including the content selection, and to send instructions to respective ones of the plurality of thin clients according to the received instructions to carry out the content selection. The video server 102 also acts as the software repository for the thin clients 104a-g, as is typical in such configurations.

The video server 102 is also preferably configured to provide a user interface that allows users (e.g., a customer service representative, a customer, a remote customer service technician showing a customer a particular brand of television, etc.) to provide instructions to the video server 102 that prompt the display of desired content on the desired television in the desired fashion.

In one alternative, described further below, the user interface is accessible through a telephone connection, so that, for example, a customer with a cellular phone may control the video server 102 and corresponding display while present in the retail point-of-sale environment. Signage in the retail environment may conveniently instruct the customer how to contact the video server (e.g., through a telephone number). Display feedback may also be used to ensure that the party controlling the displays is actually present, and not someone trying to tamper with the displays remotely. Although any number may be provided, the call in number would probably be a local number rather than an 800 number. A local number would infer a more “local” experience and not incur the extra expense to the store of a toll free number.

In addition to presenting video content, the video server 102 is configurable to store other information useful for conducting video display product comparisons and for managing the same. One example of such information is specification information for the television that is indicated as being connected to a particular thin client. This information may be manually entered by the user, or may be automatically populated, such as through an Internet connection to a source of the specification information, which would allow the user to merely identify the product in lieu of manual entry of all of the information. Text and graphics useful for describing a television product during a product presentation sequence may also be provided.

According to still another aspect, the thin clients may respectively include a an interface for a delivery of commands to the video display product to which the thin client is connected using the wireless output interface, such as an infrared blaster. This allows the thin clients to control the respective televisions to which they are connected. This is helpful for controlling the television during installation or restoring configurations to default settings, or for providing a variety of control commands to the television. Thus, if a customer wants to see the performance of television(s) with certain display settings, this may be accommodated through the user interface provided by the video server. This feature may also be useful in that it will allow a customer service representative to cause all of the televisions connected to the POSVS 100 to be re-configured to default settings, such as may be desirable at the close of a business day to ready the sets for the next day.

The content that is broadcast by the video server 102 may all be stored locally, or it may be provided to the video server 102 externally, such as through a network connection. There is no limit to the type of content that may be provided. Examples of video streams include movie trailers, teasers for network shows, sports highlights, nature, science and art shows, HD technology tutorials, and tutorial shows. In addition to content, the format of content (e.g., 1080i) is also selectable by the user. This may be accommodated by identifying content type in selection menu, or by having the user enter a format and then only displaying selections having the selected format.

The thin clients respectively include connections to the televisions. Connections may include video component, HDMI, S-Video and others. It is believed that the video component inputs to the televisions will provide a fair basis for comparing different television sets. HDMI may also be appropriate, depending upon the televisions being reviewed. Multiple connections may also be made between any thin client and any television, and the desired connection interface for reviewed content may be selected accordingly (e.g., through instructions to the video server 102 through the user interface, and corresponding instructions to the television through either the wired or infrared wireless connection to the thin client).

Finally, configuration of the system is eased through provision of a Screen Sensor/ID Tag with each thin client. The Screen Sensor/ID Tag attaches to the display face as a “decoration” which serves the purpose of labeling the TV (with the client number) and to sense what is on a predefined spot on the screen (as a form of control feedback).

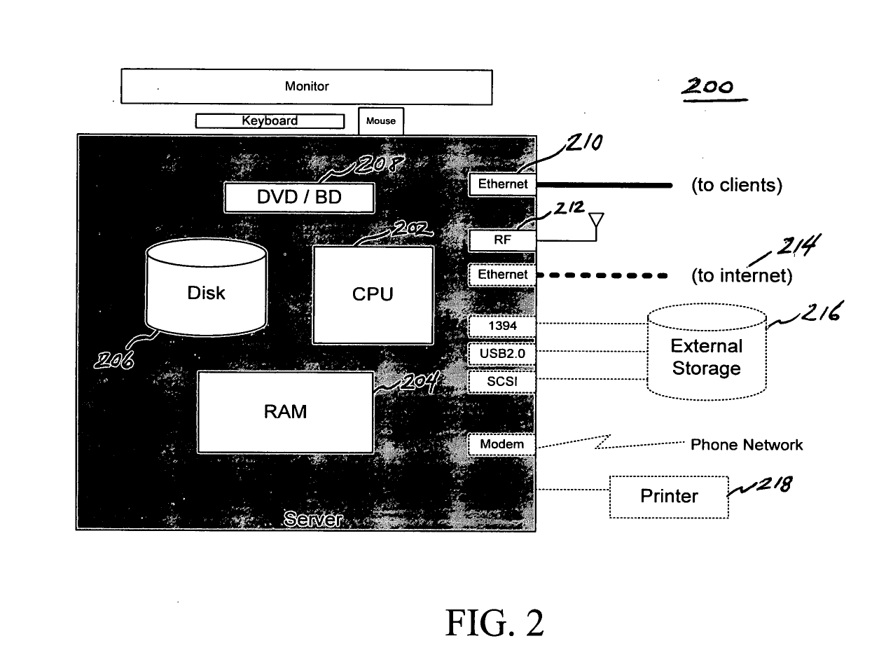

FIG. 2 is a block diagram illustrating a video server 200 from a point of sale video server system in accordance with the present invention. The video server 200 includes conventional CPU 202 and RAM 204 for executing instructions to provide the described functionality. An internal hard disk 206 stores a variety of content that is broadcast to the thin clients, preferably in the form of MPEG files. Storage and serving of content may also be accommodated through an optical drive 208 such as one having DVD or Blueray Disc technology. Keyboard, mouse and monitor functions provide one form of a user interface.

An Ethernet interface 210 allows connection to the thin clients as described, and an RF antenna 212 allows receipt of RF signals and corresponding commands, such as from an RF remote control. The video server 102 also may receive calls from (e.g., cellular) phones, and corresponding commands via a phone line and a modem.

For optional content sourcing, another Ethernet connection to the Internet 214 may be provided, and external storage 216 may be variously accessed in lieu of an internal source of storage. Such external storage 216 may be used to update the disk/memory of the video server, which then can serve the content in real time.

A printer 218 may also be connected to print customized comparisons of the specifications for particular televisions, and any other information useful for assisting customers with regard to the purchasing of television products.

Conventional interfacing with the user is also provided using keyboard, monitor and mouse operations. A user interface may also be provided through a telephone (e.g., cellular) connection as described further below.

A typical installation of the video server 200 is intended to be relatively simple, and may comprise setting up the main hardware through basic connections (main box, keyboard, mouse, display, optional printer, etc.); installing and checking alternate network connections (e.g., Internet); installing and checking telephone line connection(s); running the content distribution cables, and editing a client information database according to the desired configuration.

Telephones are one method for remote control of the system. A listing of trusted phone numbers may be maintained in the video server 300. This listing may be entered and managed during and after the installation process. The system checks caller ID for incoming calls. Trusted numbers are assumed to be store employees and are given more privileges and options. Preferably, numbers that are not on the trusted listing are passed through an authentication procedure before they can impact the system.

The Client Information Database contains information on attached clients. Parameters may be stored as a file with comma-separated-values (CSV). This facilitates maintenance with a simple text editor or spread sheet. An optional GUI style utility can be used to edit and update the file. The information may be updated during an installation or any time, such as when an associated TV is changed.

Specific information stored in the Client Information Database in association with each thin client/TV may include: (1) MAC address; (2) client number (last byte of IP address on network); (3) Interface Use flags (HDMI, component, composite); (4) TV brand; (5) TV model; (6) IR command set; (7) Price; (8) Diagonal Size; (9) Technology; (10) Native resolution (W:H); (11) Physical dimensions (H:W:D); (12) Weight; (13) Feature text (used for slow-scroll); and others. The ID Tag is matched to the other information in the CID and acts as the primary index.

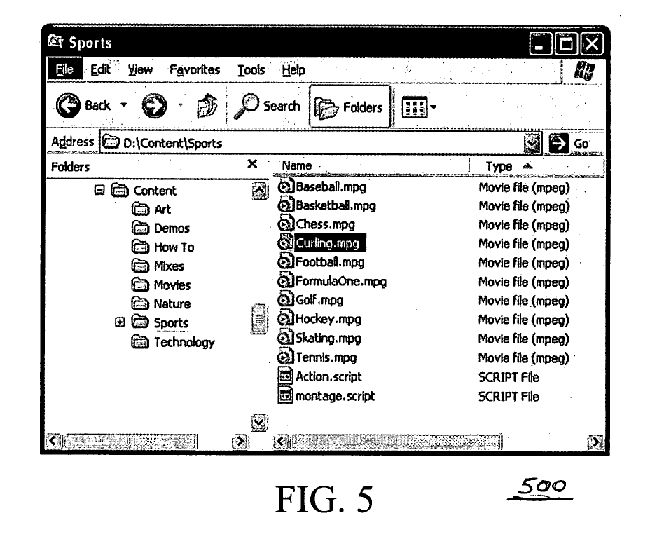

The management and provision of content of the video server 200 is further described, with concurrent reference to FIG. 2 and FIG. 5, which is a display diagram illustrating an example of a user interface 500 for accommodating the management of content on the video server.

Content streams emanate from files stored on the server. Stream files are grouped by category. The categories that show up in the on-screen custom content menus (described below) are the folder names on the video server. Adding a new folder causes a new category will show up on the menu. Videos and scripts within each folder are listed as possible selections in the custom content menu.

A stream may be a single video or a composite specified by a script. One stream is designated as the default display for all TVs. The content distributed as available auxiliary streams are selected via remote control. Preferably, the streams play in a loop until other streams are selected, and the three streams are zipped together and broadcast to all the TVs on the network.

Videos are the simplest form of stream since they are self standing. Video files are preferably in MPEG2 transport stream format. Videos can be imported into the system using tools applicable to any generic file. They can also be captured from standard feeds (e.g., tuner, cable, satellite) or originated using a camcorder.

Scripts are a sequence of simple commands that string together videos, stills, and other components to form a composite stream. A text editor is used to compose and revise the sequential command lines. These command lines are saved in script files. Script files can also reference other script files. Four command types are used to build scripts—PLAY, SHOW, OVERLAY, and SUBSCRIPT. An example script file might consist of the following commands:

| | |
|---|---|
| SHOW storelogo.jpg 10 | // show store logo for 10 seconds |
| PLAY montage.mpg | // play video from start to finish |
| OVERLAY format_n_brand.ovl | // overlay format and brand onto |
| | future video |
| PLAY formatmedly.mpg | // play video from start to finish |
| OVERLAY | // overlay “nothing” onto future video |
| SHOW storelogo.jpg 10 | // show store logo for 10 seconds |
| SUBSCRIPT showspec.script | // perform subscript |

PLAY is used for including all or part of a video file. The PLAY command is followed by the path name to access the desired video file. Optional starting and ending frame numbers may be provided for partial playbacks.

SHOW is used for including a still image. The first argument is the path name to access the desired image. A second argument is the number of seconds to display. A default time, such as 5 seconds, is also provided.

OVERLAY controls what information (if any) is overlaid upon the video or image. This layering permits specific information to be shown and is the basis for dynamic signage. The selected overlay file defines the location and content to be overlaid. Specific content can include text and graphics. The specified overlay persists until it is replaced by a subsequent overlay.

Note that streams and stills include embedded resolution information that can also be included in the overlays. Streams may also include triggers (special PIDs) to change information in the overlay at key points in the stream. Action data overlaid can originate from the client specific database. Thus, for example, client-specific data such as diagonal dimension is sent to and stored at the client in non-real time. The triggers cause the stored data to be inserted into the display as directed by the template distributed as part of the stream, which is seen simultaneously by many clients. The template prompts displays of information (e.g., show the diagonal dimension and weight in the lower right hand corner).

SUBSCRIPT specifies the name of another script file that is executed as a form of subroutine. (e.g., a frequently used sequence of instructions can be included by reference.)

The video server may be preloaded with a startup set of content. Additional files can be brought onto the server using any number of common file transfer methods. Small files can be downloaded via the Internet. Larger files can be ported on CDs or data DVDs. Portable large disks can be used for bulk transfers and updates. Portable disks that interface via USB2.0 or 1394 are available as commodity items with hundreds of gigabyte capacities.

The server can be connected to a corporate network as well as the TV client network. Even large files can be transferred over this network especially if GigE support is available. Internet transfers are only practical for small files while shipping physical media is more appropriate for large files.

The video server is also configured with utilities to determine PIDs in the content files. Files should be re-mapped with PID numbers matching what is expected by the thin clients.

The video server stores a variety of configuration information useful for managing the provision of particular content to thin clients. Specific information maintained in the video server includes the Client Information Database, which is described above; the Available Content Directory, which contains and defines the hierarchy of categories and file lists within each category available for display; the Trusted Phone List, which contains a list off all phone numbers known to the system so that special privileges can be afforded, including ability to perform client setup and avoid specific authentication each time a connection is made; and an Activity Log, which contains a log of all remotely controlled activity including phone numbers and content visited.

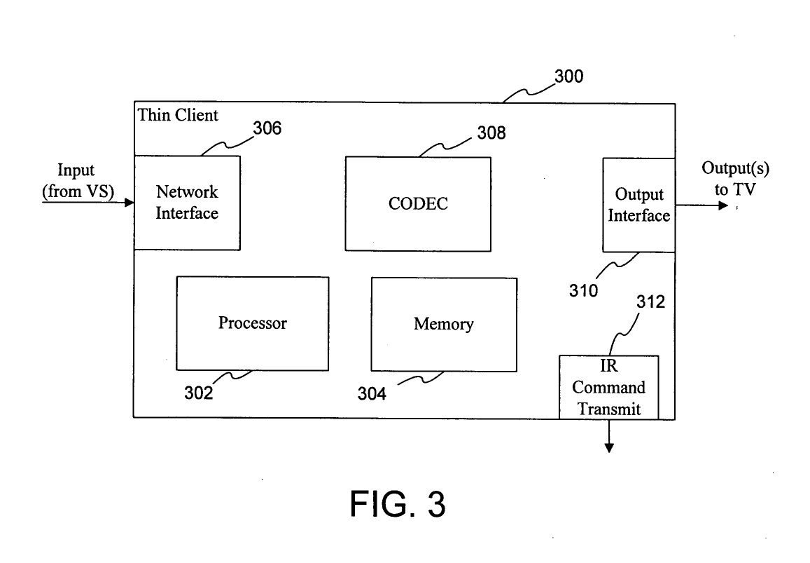

FIG. 3 is a block diagram illustrating a thin client 300 from a point of sale video server system in accordance with the present invention. The thin client 300 includes a CPU 302 and memory 304 to execute and store instructions that provide the described functionality. The memory 304 comprises RAM that accommodates buffering of the video signals received, decoded and transmitted by the thin client 300. Non-volatile flash memory may also be provided to accommodate provision of start up sequencing and to retain storage of configuration settings for a given thin client.

A network interface 306 allows receipt of the selected video streams from the video server. The video server stores the network address of the various thin clients and thus addresses the content selected by the user to the appropriate thin client. The feeds are broadcast by the video server and thus are available to any and all clients simultaneously. Uniquely addressed commands are respectively sent to client(s) to control which stream should be displayed. The thin client 300 also includes a codec 308 that accommodates decoding of the signals received from the video server as well as encoding according to the desired output. Preferably, an MPEG codec is implemented, but any alternative video and/or audio encoding protocols may also be provided.

The thin client 300 also includes an output interface 310. The output interface 310 is configured to include at least one output, and any desired number or variety of outputs may be provided, such as HDMI, DVI, YPbPr, S-Video, and Composite video. The thin client 300 thus decodes content from the stream and outputs images using the selected interface.

The thin client 300 also includes an infrared transmitter 310 that is used to transmit IR signals used to control a connected television set using the IR blaster. The IR blaster LED may be attached on front of the set as appropriate for the TVs native sensor, using gaffers tape or any other suitable method.

Initialization and control to select content are now further described. Although the user interface may be directly at the server, according to one aspect the interface is provided remotely through a cellular phone. The phone should have a headset for optimum convenience when following voice prompts and pushing buttons. The solicitations for cell phone input assume that the user is following voice prompts. Voice prompts are preferably used during the initial authentication procedure, with on screen prompts and the phone keypad being used once connection is established.

An initial part of the configuration involves verification that the configuration table matches the MAC address and ID tag on the screen sensor. The combination screen sensor and ID tag are installed as part of the TV initialization procedure.

The ID tag attaches to the TV screen using a suction cup that doubles as a screen sensor. Initial configuration may involve some form of verification that the configuration database shows the associated client is in setup mode (i.e., prompts to ensure that the physical connection is as reflected in the database), and power cycling the thin client to prompt initialization. At this point the thin client asserts the setup screen on all outputs.

The cellular phone is used to call the video server access number, and a key such as the star key launches the setup. The ID tag number (consistent with the configuration database) is then entered. The thin client sends IR commands via the IR blaster to turn on and select input connected to client. The user may confirm, prompted by a voice command query that the setup screen is displayed. The suction cup of the screen sensor is then attached over the indicated dot on the screen.

The thin client validates the viability of the screen sensor viability and starts input path verification. The user is prompted to confirm correct operation of all inputs by following on screen prompts. Once all of the inputs have been confirmed, the client may switch to playing a default stream.

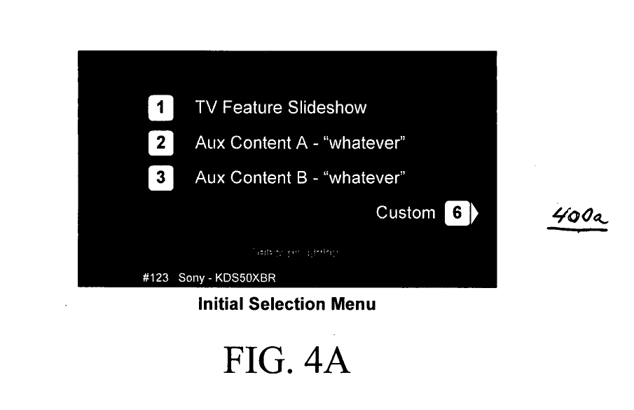

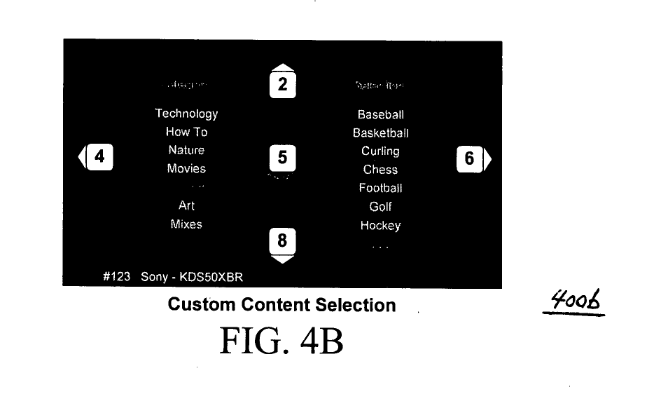

FIGS. 4A-B are display diagrams 400a, 400b illustrating examples of a user interface for providing instructions to the video server to select content in accordance with the present invention. In this example, the content selection uses cell phones for remote control. The video server answers the phone and detects key presses as input selection.

An example of the initial connection following receipt of the call progresses as follows. First, the user is asked to enter the client number, which is done using the cellular phone keypad. Repeat entry of the information can be used to ensure accurate entry of the information. If the caller ID shows that the caller is not on the “trusted” list, then a random number is displayed on the television connected to the thin client, and the user is asked to enter that number. This ensures that the user is present at the location, and not remotely tampering with the settings using the telephone access number. If the number is on the trusted list, this process bypasses this screening step.

Once verified to be trusted or authenticated, the current stream will stop and a simple pick by number menu appears on the display. Pressing a key starts the selection immediately. Once play has started, any key entry will return to the previous menu. Hanging up the phone will restore the screen display to a stream specified in the Client Information Database.

Some examples of options are illustrated in the display diagram 400a of FIG. 4A. The client number and information corresponding to the client number, such as the television brand and model information from the configuration database, may be persistently displayed at the bottom of the screen so that the user is reminded of the currently operated set, and so that any incorrect information in the configuration database may be easily noticed. Option 1 selects a slide show built on-the-fly by the client from specification data for the selected TV(s). Options 2 & 3 select “whatever” is already being streamed on those feeds.

Option 6 prompts the display of a new window that is used to customize content selection. An example of this is illustrated in the display diagram 400b of FIG. 4B. Custom content is easily selected by keystrokes. Pressing 2 & 8 scroll up and down through columns, and pressing 4 & 6 moves left and right between category and selection (or window changes). Once the cursor is over the desired content, pressing 5 will start the selection playing. Again, any keystroke during play will return to the menu and hanging up will resume the default stream.

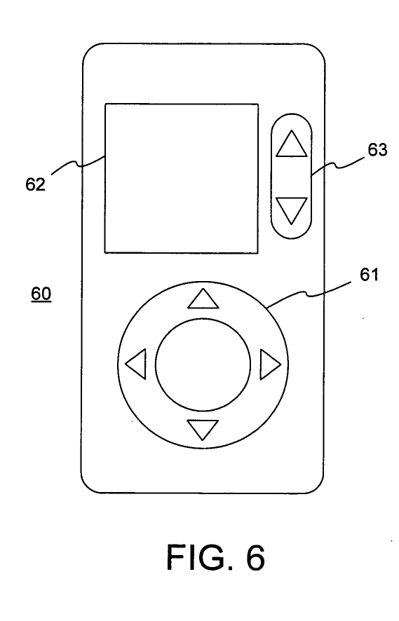

Alternative control systems may also be provided, including but not limited to those that implement control through a remote using RF signals. FIG. 6 shows a representative RF remote 60 contemplated to be available to each sales associate on the sales floor. The TVs are selected by the thumbwheel 61 as is an on-screen menu 62 to select content by an indexer 63. Thus, for the same array of television sets, sales associates assisting multiple customers can tailor the video presentation in a way that is judgmentally best responsive to the inquiries of the potential customer and/or to demonstrate features of interest of a brand TV.

Thus, a variety of content can be flexibly stored and delivered to customers reviewing and comparing televisions in accordance with the present invention. For example, the server may provide unit demos to match interests and questions posed by the consumer to be selected either by a sales associate or a consumer. Unit demos are pre-programmed to orchestrate a combination of content streams and IR Commands transmitted to the TV. Content may include sufficient information to compare two modes of the TVs as to a multitude of features, such as model, price, size, clarity, aspect ratio, bordering, technologies, brands, sources, warranties, delivery features, availability and purchase terms. Content may also include educational material such as tutorials on tradeoffs between LCD, plasma and DLP technologies. Furthermore, content in different formats, i.e. 480P, 720p, 1080i or the like, can show how each floor model performs based on input. Loops could include sports programs to check motion blur and slow pan still life images to show off detail of selected TVs.

Another feature of the invention is that with the diverse content streams, several different sales associates can demonstrate simultaneously to other customers on other TVs. By way of example, a first sales associate can respond to a consumer inquiry for color range, while a second sales associate can show motion by a sports collection, while a third sales associate can show nature, science and art shows drawn from the representative content options.

The system is also designed to accommodate easy management. A new TV can easily be added to the system for display on the showroom floor by merely connecting a thin client and associated cables, with set up of the new television being easily followed through prompts as described.

Additionally, content sourcing is flexible as described. In addition to that stored in the video server, content can be provided by a central external source. An example of this feature is where a manufacturer prefers to have its own network for providing information to its distribution network from a central source on either a real time basis or from a stored central location. Manufacturer A may prefer to provide information from a central source to its network of interconnected servers, while Manufacturer B may prefer to provide information from a central source to an external source for downloading to a server for practicing the invention. Preferably, content from a central source will be cached on the video server to ensure that playback will not be impacted by bandwidth limitations of the central server link.

The system may also be configured so that the thin client has the ability to output a degraded signal. That is, the voltage levels and timings from the client to the TV can be adjusted “out of spec” to demonstrate the TV's ability to recover. This could, for example, be used to simulate how a TV would reproduce a picture from an old VHS tape.

These and other features of the invention will be apparent from a reading of the foregoing description. However, the invention described in the above detailed description is not intended to be limited to the specific form set forth herein, but is intended to cover such alternatives, modification and equivalents as can reasonably be included with the spirit and scope of the appended claims.

1. A system for facilitating the presentation of video display products in a point-of-sale retail environment, the system comprising:
a server, which stores a plurality of video streams that relate to a plurality of video display products, wherein the server is configured to serve the plurality of video streams;
a plurality of thin clients, configured to include an input to receive the served plurality of video streams from the server and an output to deliver content to at least one of the plurality of video display products, wherein each of the plurality of thin clients is respectively configured to be addressable to select content from the plurality of video streams, such that a given thin client that is connected to a given display product transmits selected content available from the plurality of video streams to the given display product according to a content selection.

2. The system of claim 1, wherein each of the plurality of thin clients includes a decoder, with the decoder being used to decode at least one of the plurality of video streams according to the content selection.

3. The system of claim 1, wherein the server is configured to store information that allows the plurality of thin clients to be respectively addressed, to receive instructions including the content selection, and to send instructions to respective ones of the plurality of thin clients according to the received instructions to carry out the content selection.

4. The system of claim 3, wherein the server is configured to receive the instructions through a user interface presented at the location of the point-of-sale retail environment.

5. The system of claim 3, wherein the server is configured to receive the instructions through a user interface that is accessed through a telephone number, such that a user in the point-of-sale retail environment is accommodated access to the user interface through the telephone number to allow the user to select content to be displayed on the plurality video display products.

6. The system of claim 1, wherein the server stores specification information respectively associated with individual ones of the plurality of thin clients, the specification information corresponds to the video display products to which the plurality of thin clients are respectively connected, and wherein the content selection causes the specification information to be displayed on the respective ones of the plurality of video display products during a product presentation sequence.

7. The system of claim 6, wherein the server is configured to provide a user interface that allows customized entry of the specification information.

8. The system of claim 1, wherein the plurality of thin clients respectively include a wireless output interface for a delivery of commands to the video display product to which the thin client is connected using the wireless output interface.

9. The system of claim 8, wherein the wireless output interface is an infrared blaster.

10. The system of claim 1, wherein the connection between the server and respective ones of the plurality of thin clients is an Ethernet cable.

11. The system of claim 1, wherein one or more of the plurality of video streams are provided to the server from an external source of content.

12. The system of claim 1, wherein the plurality of video streams include at least one of movie trailers, teasers for network shows, sports highlights, nature, science and art shows, HD technology tutorials, and tutorial shows.

13. A method for facilitating the presentation of video display products in a point-of-sale retail environment, the method comprising:
causing a server to transmit a plurality of video streams that provide content that relates to a plurality of video display products to a plurality of thin clients that are connected to the plurality of video display products; and
updating a configuration of at least one of the plurality of thin clients that receive the plurality of video streams, wherein each of the plurality of thin clients is respectively addressable to select content from the plurality of video streams according to the updated configuration, such that a given thin client that is connected to a given display product transmits selected content available from the plurality of video streams to the given display product according to a content selection.

14. The method of claim 13, wherein the server stores specification information respectively associated with individual ones of the plurality of thin clients, the specification information corresponds to the video display products to which the plurality of thin clients are respectively connected, and wherein the content selection causes the specification information to be displayed on the respective ones of the plurality of video display products during a product presentation sequence.

15. The method of claim 14, wherein the server is configured to provide a user interface that allows customized entry of the specification information.

16. A video server for facilitating the presentation of content on video display products in a point-of-sale retail environment, the video server comprising:
means for transmitting a plurality of video streams having content relating to a plurality of video display products to a plurality of thin clients respectively connected to a plurality of video display products; and
means for updating a configuration corresponding to at least one of the plurality of thin clients that receive the plurality of video streams, wherein each of the plurality of thin clients is respectively addressable to select content from the plurality of video streams according to the updated configuration, such that a given thin client that is connected to a given display product transmits selected content available from the plurality of video streams to the given display product according to a content selection.

17. The video server of claim 16, wherein the server is configured to store information that allows the plurality of thin clients to be respectively addressed, to receive instructions including the content selection, and to send instructions to respective ones of the plurality of thin clients according to the received instructions to carry out the content selection.

18. The video server of claim 17, wherein the server is configured to receive the instructions through a user interface presented at the location of the point-of-sale retail environment.

19. The video server of claim 18, wherein the server is configured to receive the instructions through a user interface that is accessed through a telephone number, such that a user in the point-of-sale retail environment is accommodated access to the user interface through the telephone number to allow the user to select content to be displayed on the plurality video display products.

20. The video server of claim 16, wherein the server stores specification information respectively associated with individual ones of the plurality of thin clients, the specification information corresponds to the video display products to which the plurality of thin clients are respectively connected, and wherein the content selection causes the specification information to be displayed on the respective ones of the plurality of video display products during a product presentation sequence.
